(19) United States
(12) Patent Application Publication
(10) Pub. No.: US 2006/0283315 A1
(43) Pub. Date: Dec. 21, 2006

(54) Weapon release cable retention device and method

(76) Inventor: Rick J. Blackburn, Indianapolis, IN (US)

Correspondence Address: Jonathan A. Platt;Renner, Otto, Boisselle & Sklar, LLP, Nineteenth Floor, 1621 Euclid Avenue, Cleveland, OH, 44115, US

(21) Appl. No.: 11/146,254

(22) Filed: Jun. 6, 2005

(51) Int. Cl. B64D 1/04; B64D 1/12

(52) U.S. Cl. 89/1.54; 244/137.4

(57) ABSTRACT

A weapons cable retention device is used for separating an electrical connection, and retaining a cable and an electrical connector coupled to an aircraft, when a munition, such as a bomb or a missile, is released from the aircraft. The cable retention device includes a structural coupling for coupling to the aircraft, a rod having an adjustment mechanism for adjusting the length of the rod, and an attachment mechanism for attaching to the electrical connector. The cable retention device provides a substantially rigid coupling to secure the electrical connector. The cable retention device may be configured so that the attachment mechanism engages lanyard holes of a standard electrical connector. According to one embodiment, the structural coupling may include a collar that receives a bail bar on the aircraft structure through a hole therein.

### BACKGROUND OF THE INVENTION

1. Technical Field of the Invention

The invention relates to a device for retaining a cable and electrical connector during release of a weapon, such as a bomb or a missile.

2. Description of the Related Art

For many types of modern munitions, such as smart bombs, it is desirable to maintain an electrical connection to the munition prior to release of the munition from an aircraft. FIG. 1 illustrates a prior art system and method of making a releasable electrical connection to a munition. A munition 10 is mounted to an aircraft structure 12, such as a pylon 14, by releasable mechanical connections 16 and 18. A releasable electrical connection 20 is also made between a receptacle 22 of the munition, and an electrical connector 24, which is coupled to the electrical system of the aircraft by a cable 28. A cable retention system 30 is used to release the electrical connection 20 when the munition 10 is released from the aircraft structure 12, as illustrated in FIG. 2. The electrical connector 24 and the cable 28 are thus retained with the aircraft when the munition 10 is released. The cable retention system 30 includes a lanyard 34, which is looped over a bail bar 36 that is part of the aircraft structure 12. (The bail bar 36 is a piece of aircraft structure that may be moved or disconnected at one end, for example to allow the lanyard 34 to be looped over it.) As shown in FIGS. 3 and 4, the lanyard 34 engages lanyard ring holes 38 in a lanyard ring 40 of the connector 24. Ends of the lanyard 34 may be looped through the pairs of lanyard ring holes 38 on opposite sides of the lanyard ring 40. Thus, loops 42 may be formed in the ends of the lanyard 34, which may be secured by tape 44 or by crimped sleeves. The lanyard 34 is a heavy cord that is able to withstand the pull forces when the munition 10 is released from the aircraft structure 12. When the munition 10 is released, the lanyard 34 is released, and the lanyard 34 pulls upward on the lanyard ring 40. Pulling upward on the lanyard ring 40 causes activation of an internal mechanism (not shown) within the connector 24, which releases the connector 24 from the receptacle 22.

Many requirements are imposed regarding installation of the lanyard 34. For instance, a specified range of links of the lanyard 34 is provided, in order to leave a desired amount of slack. Also, a maximum pull angle for the lanyard 34 is specified.

Nevertheless, many problems have been found associated with use of the lanyard 34 to separate the electrical connection 20. Among these problems are broken or frayed lanyards. Also, damage to the electrical connector 24, such as breaking, deforming, or damage to some of the electrical contacts, has also been observed. Further, non-uniformities in different releases of the cable retention system 30 may cause different forces to be placed upon the munition 10 during its release, effecting the trajectory of the munition 10. In practice, the prior art cable retention system 30 suffers failures every one to three releases of the munition 10.

One improvement to the cable retention system 30 that previously has been tried, has been to include lanyard reeling devices for reeling in the lanyard 30. These lanyard reeling devices are affixed to an aircraft, or aircraft structure, such as a pylon. However, the addition of lanyard reeling devices engenders difficulties because such lanyard reeling devices are considered modifications to the aircraft, which may be difficult to secure approval for use of such devices. In addition, lanyard reeling device solutions do not control the attitude of the weapons interface connector, during separation of the weapon or munition from the aircraft.

From the foregoing, it will be appreciated that improvements in this area would be desirable.

### SUMMARY OF THE INVENTION

In accordance with an aspect of the invention, a weapons cable retention device provides a substantially rigid coupling between an electrical connector and aircraft structure, such as a bail bar.

In accordance with another aspect of the invention, a weapons cable retention system includes at one end a collar for receiving a bail bar, and at an opposite end an attachment for coupling to a lanyard ring.

In accordance with yet another aspect of the invention, a weapons cable retention device includes a variable-length rod, with a coupling to aircraft structure at one end of the rod, and a coupling to an electrical connector at an opposite, second end of the rod.

According to still another aspect of the invention, a weapons cable retention device includes a rod, with an offset collar at one end of the rod, wherein the offset collar has an offset hole therein, such as for receiving a bail bar of aircraft structure, offset from an axis of the rod.

According to a further aspect of the invention, an aircraft weapon release cable retention device includes: a structural coupling configured to couple to aircraft structure; an attachment mechanism configured to couple to an electrical connector; and a substantially-rigid rod attached to the structural coupling and the attachment mechanism. The rod may have an adjustable length.

According to a still further aspect of the invention, an aircraft weapon release cable retention device includes: a collar with a collar hole therethrough, for receiving at least part of an aircraft structure therethrough; a forked end with two legs configured to engage the electrical connector; and an adjustable-length rod attached to the collar and the forked end. A collar hole axis of the collar hole is in a direction at a nonzero angle to a rod axis of the rod. The legs each have a pair of leg holes therein configured to receive a pair of ties therethrough, to secure the legs to the electrical connector.

According to another aspect of the invention, a method of releasably coupling a munition to an aircraft, includes the steps of: mechanically coupling the munition to aircraft structure of the aircraft; electrically coupling an electrical connector of the aircraft to an electrical receptacle of the munition; and securing to the aircraft structure, with a cable retention device, both the electrical connector and a cable coupled to the electrical connector. The cable retention device includes: a structural coupling; an attachment mechanism; and a substantially-rigid, adjustable-length rod attached to the structural coupling and the attachment mechanism. The securing includes: coupling the structural coupling to the aircraft structure; and coupling the attachment mechanism to the electrical connector, such that the electrical connector is de-coupled from the electrical receptacle when the munition is released from the aircraft.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is an oblique view of a prior art cable retention system, used to couple together an electrical connection with a munition;

FIG. 2 illustrates the munition of FIG. 1 being released;

FIG. 3 is an oblique view showing greater details of the prior art cable retention system of FIG. 1;

FIG. 4 is a detailed view showing details of coupling of a prior art lanyard to a lanyard ring of an electrical connector;

FIG. 5 is an oblique view showing a generalized cable retention device in accordance with the present invention, coupling to an electrical connector of an electrical connection with a munition;

FIG. 6 is an oblique view of a first embodiment of a cable retention device in accordance with the present invention;

FIG. 7A is an exploded view showing details of the adjustment mechanism of the cable retention device of FIG. 6;

FIG. 7B is a partial sectional view of a portion of the adjustment mechanism;

FIG. 8 is an oblique view showing the cable retention device of FIG. 6 in an installed configuration;

FIG. 9 is an oblique view of a second embodiment cable retention device in accordance with the present invention; and

FIG. 10 is an oblique view showing a third embodiment cable retention device in accordance with the present invention.

### DETAILED DESCRIPTION

A weapons cable retention device is used for separating an electrical connection, and retaining a cable and an electrical connector coupled to an aircraft, when a munition, such as a bomb or a missile, is released from the aircraft. The cable retention device includes a structural coupling for coupling to the aircraft, a rod having an adjustment mechanism for adjusting the length of the rod, and an attachment mechanism for attaching to the electrical connector. The cable retention device provides a substantially rigid coupling to secure the electrical connector, thereby reducing variability in release forces on the electrical connector, and increasing the chance of a successful release of the munition, that does not damage the electrical connector and does not unacceptably affect the attitude of the munition. The cable retention device may be configured so that the attachment mechanism engages lanyard holes of a standard electrical connector. According to one embodiment, the structural coupling may include a collar that receives a bail bar on the aircraft structure through a hole therein. Alternatively, the structural connector may attach to the structure in other ways, such as being bolted to the aircraft structure.

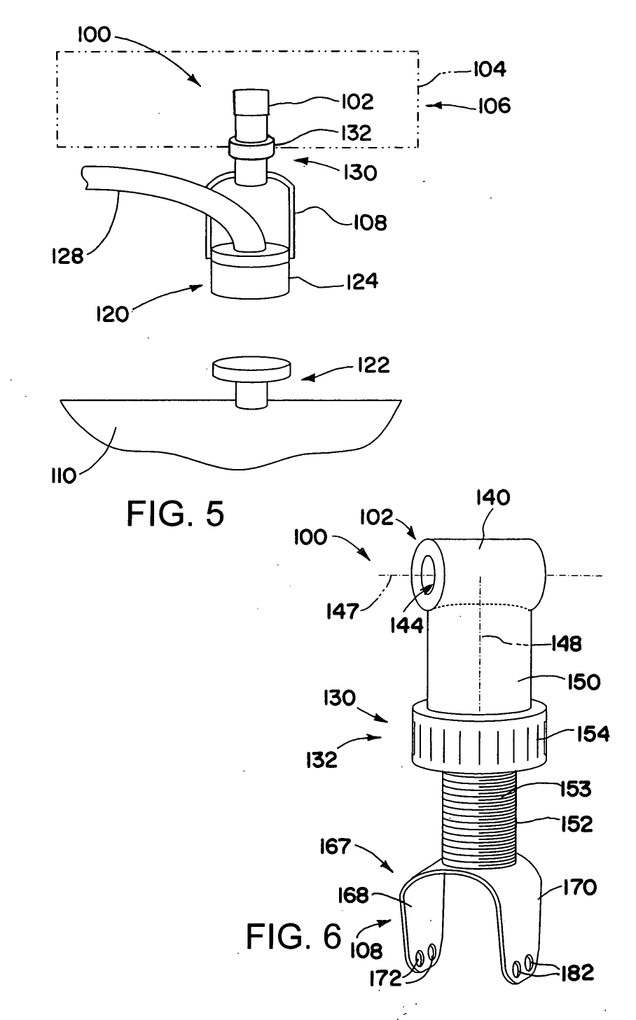

FIG. 5 shows the general layout of an aircraft weapon release cable retention device 100 that includes a structural coupling 102 for coupling to an aircraft structure 104, such as a weapons pylon 106. The cable retention device 100 also includes an attachment mechanism 108 for attaching to an electrical connector 124 that is part of an electrical connection 120 that also includes a receptacle 122 on a munition 110. The electrical connection 120 is used to provide electrical connection, via a cable 128 between the aircraft and the munition 110. The munition 110 may be any of a variety of releasable munitions, such as a bomb, smart bomb, guided missile, etc. The cable retention device 100 includes a substantially-rigid rod 130 that connects to the structural coupling 102 and the attachment mechanism 108. An adjustment mechanism 132 is provided for adjusting the length of the rod 130, and/or for adjusting the overall length of the device 100.

The cable retention device 100 provides a way of substantially rigidly coupling the electrical connector 124 to the aircraft structure 104, in order to retain the electrical connector 124 and the cable 128 when the munition 110 is released from the aircraft. The electrical connector 124 may be, for example, a connector meeting the requirements of MIL-STD-1760. It will be appreciated that many variations are possible for the broadly-described device 100. What follows now are some of the many variations for the cable retention device 100.

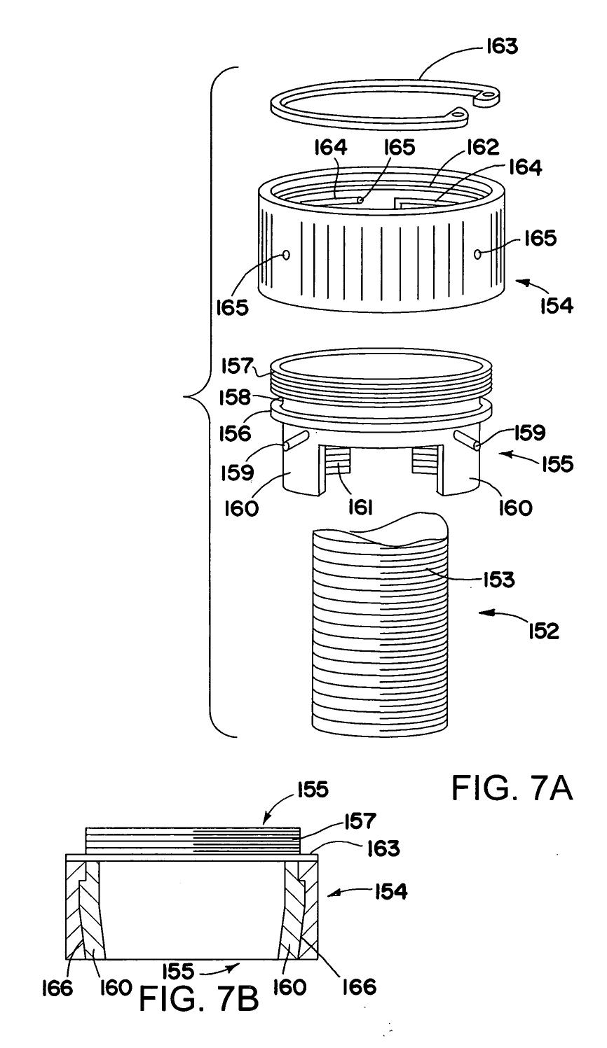

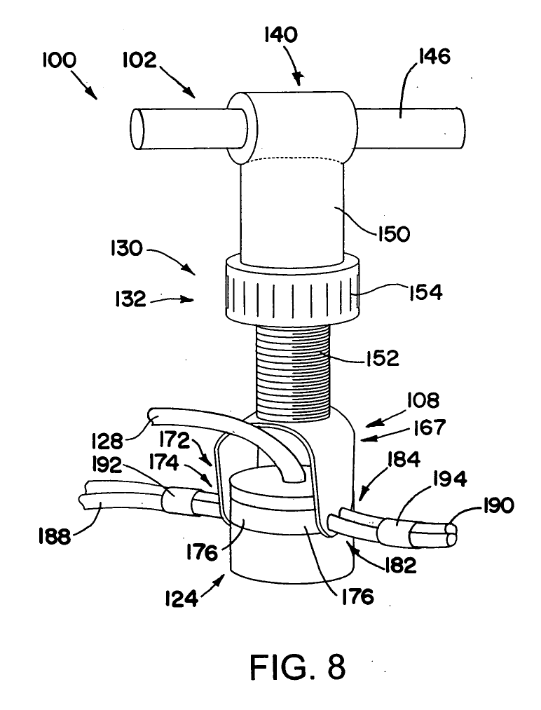

FIGS. 6-7B show an embodiment of the cable retention device 100 wherein the structural coupling 102 is a bar collar 140 having a bar-receiving collar hole 144 therein. As shown in FIG. 8, the bar collar 140 may be configured so as to receive a bail bar 146 through its bar-receiving holes. A collar hole axis 147 of the collar hole 140 is in a direction at a nonzero angle relative to a rod axis 148 of the adjustable rod 130. That is, the collar hole axis 147 is not collinear with and is not parallel to the rod axis 148. Indeed the collar hole axis 147 may be in a direction substantially perpendicular to the direction of the rod axis 148. The collar hole axis 147 may substantially intersect the rod axis 148.

The adjustable rod 130 includes a pair of telescoping parts: a sleeve 150, which may be integrally formed with the bar collar 140, and a plunger bar 152. The plunger bar 152 fits into the sleeve 150 and may be locked into place at varying positions relative to the sleeve 150, by action of the adjustment mechanism 132. The plunger bar 152 has a series of circumferential grooves 153. The grooves 153 may be engaged, as part of the adjustment mechanism 132, for setting the relative positions of the sleeve 150 and the plunger bar 152.

The adjustment mechanism 132 includes an outer coupler 154 and an inner coupler 155, which combine to secure the plunger bar 152 in a desired location relative to the sleeve 150. The inner coupler 155 includes a central shelf 156, an externally-threaded portion 157 for engaging corresponding internal threads in sleeve 150, and a groove 158 between the central shelf 156 and the externally-threaded portion 157. On an opposite side of the central shelf 156, the inner coupler 155 has bayonets 159 protruding radially from the body of the inner coupler 155. Also on that side, the inner coupler 155 has downward-extending fingers 160. The fingers 160 have inner grooves 161, configured to engage the circumferential grooves 153 of the plunger bar 152. In the illustrated embodiment, the inner coupler 155 has two fingers 160 and four bayonets 159, although it will be appreciated that other suitable numbers of fingers and/or bayonets may be employed.

The outer coupler 154 includes a central shelf 162 on an inner surface. The central shelf works in conjunction with a retaining ring 163 and the central shelf 156 of the inner coupler 155 to maintain the couplers 154 and 155 mechanically coupled together. The outer coupler also has bayonet grooves 164 on its inner surface. The bayonet grooves 164 have longitudinal portions for receiving the bayonets 158 as the inner coupler 155 is inserted into the outer coupler 154. The bayonet grooves 164 also have longitudinal portions for retaining and guiding the bayonets 159 as the outer coupler 154 is rotated, after the inner coupler 155 has been inserted into the outer coupler 154. The longitudinal portions of the bayonet grooves 164 conclude in bayonet-receiving holes 165, for receiving and securing the bayonets 159.

The outer coupler 154 has inner cam surfaces 166 which have different in radial distance from the axis of the outer coupler at different circumferential locations about the outer coupler axis. The cam surfaces 166 are designed to engage and push inward the fingers 160 as the outer coupler 154 is rotated relative to the inner coupler 155. As the fingers 160 are pressed inward, the inner grooves 161 of the fingers 160 engages the circumferential grooves 153 of the plunger 152, locking the plunger bar 152 to the inner coupler 155.

Assembly of the adjustable rod 130 may be accomplished by first coupling together the couplers 154 and 155. The inner coupler 155 is inserted into the outer coupler 154 until the central shelf 156 of the inner coupler 155 comes into contact with the shelf 162 of the outer coupler 154, with the externally-threaded portion 157 extending beyond the opposite end of the outer coupler 154. For insertion, the inner coupler 155 is oriented relative to the outer coupler 154 such that the bayonets 159 engage the longitudinal portions of the bayonet grooves 164.

After insertion, the inner coupler 155 is secured to the outer coupler 154 by placing the retaining ring 163 in the ring-retaining groove 158 of the inner coupler 155. The couplers 154 and 155 may then be secured to the sleeve 150 by screwing the externally-threaded portion 157 of the inner coupler 155 into the corresponding threads of the sleeve 150. A suitable adhesive may be applied to maintain the externally-threaded portion 157 engaged with the sleeve 150.

Then the plunger 152 may be inserted into the couplers 154 and 155, and into the sleeve 150, by the desired amount to get the desired length of the adjustable rod 130. Once a desired amount of insertion of the plunger 152 is achieved (to achieve a desired length for the adjustable rod 130), the plunger 152 may be locked into place by twisting the outer coupler 154. Twisting the outer coupler 154 causes the cam surfaces 166 to press inward against the fingers 160, causing the inner grooves 161 of the fingers 160 to engage the circumferential grooves 153 of the plunger 152, locking the plunger bar 152 to the inner coupler 155. Simultaneously the twisting causes the bayonets 159 to move within the circumferential portions of the bayonet grooves 164 until the bayonets 159 engage the bayonet holes 165.

With the bayonets 159 in the bayonet holes 165, further twisting of the outer coupler 154 in either direction is discouraged. It will be appreciated that a one-quarter turn of the outer coupler 154 may be sufficient to move the outer coupler 154 in a locked position. It will further be appreciated that the bayonets 159 may be released from the bayonet holes 165 by sufficiently strong twisting, in order to release the plunger bar 152 to allow re-adjustment of the plunger bar 152.

The adjustable rod 130 may have a length that is adjustable, for example, from about 114 mm (4.5 inches) to about 178 mm (7 inches), although it will be appreciated that a wide range of suitable adjustments may be obtainable.

The attachment mechanism 108 includes a fork 167 that is attached to the plunger bar 152. The fork has a pair of legs 168 and 170. The leg 168 has a pair of attachment holes 172 for engaging corresponding lanyard ring holes 174 of a lanyard ring 176 of the electrical connector 124. The leg 170 has a similar pair of attachment holes 182 for engaging another pair of lanyard ring holes 184. The holes in the legs 168 and 170, and in the lanyard ring 176, may be engaged with a pair of ties 188 and 190, diametrically opposed on opposite sides of the lanyard ring 176. The ties 188 and 190 may be maintained in the holes of the fork 167 and the lanyard ring 176 by use of crimp collars or tape strips 192 and 194.

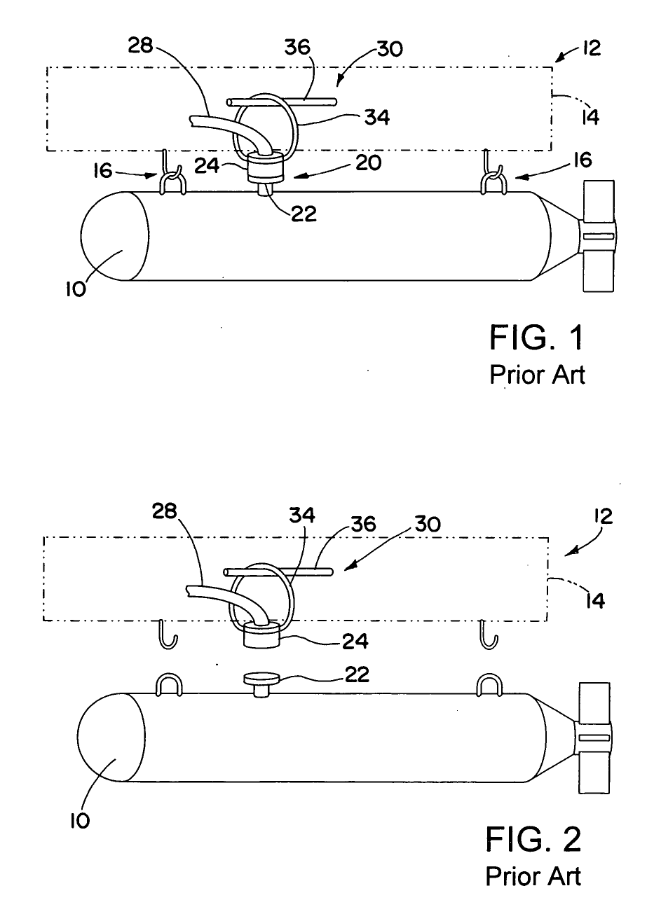

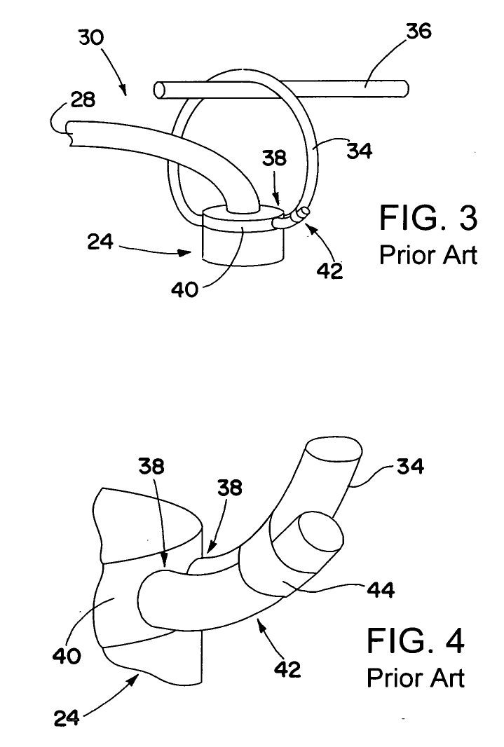

It will be appreciated that the use of the ties 188 and 190, and the crimp collars 192 and 194, allows for some limited amount of play between the fork 167 and the lanyard ring 176. A certain amount of play in the coupling between the cable retention device 100 and the electrical connector 124 is desirable, since there is some amount of play in the mechanical coupling of the munition 110 to the aircraft structure 104. The munition 110 may be mechanically coupled to the aircraft structure 104 by use of items such as hooks and sway bars, which are not fully rigid connections. Accordingly, it is desirable that the coupling between the cable retention device 100 and the electrical connector 124 also not be fully rigid. The use of the flexible ties 188 and 190 may provide a desired amount of play between the cable retention device 100 and the electrical connector 124. The amount of play in use of the ties 188 and 190 may be less than that of the prior art system shown in FIGS. 1-4, utilizing the lanyard 34 draped over the bail bar 36.

The ties 188 and 190 may be made of a suitable flexible material, such as a material similar to that of the lanyard 34.

As an alternative to the use of the ties 188 and 190, suitable fasteners, such as rivets, may be inserted through the attachment holes 172 and 182, and into the lanyard ring holes 174 and 184.

The various parts of the cable retention device 100 may be made of any of a variety of suitable materials. For example, the cable retention device 100 may be made of suitable metals such as aluminum, which is strong, yet is lightweight.

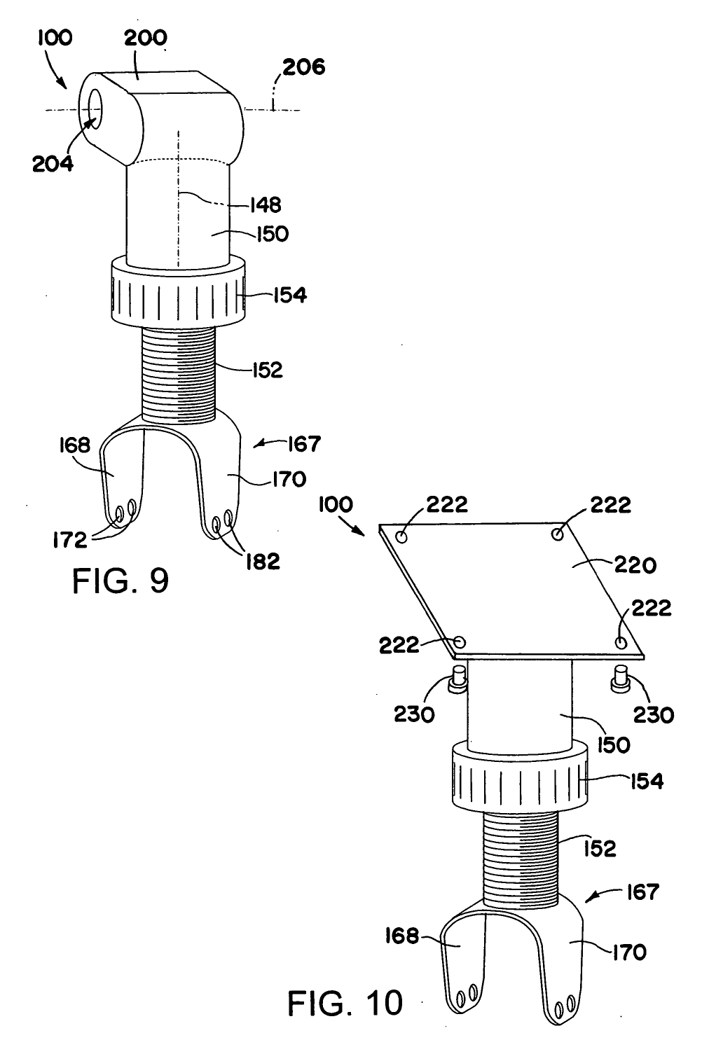

FIG. 9 shows an alternative embodiment of the cable retention device 100, in which the structural coupling 102 includes an offset bar collar 200 with an offset bar-receiving hole 204 therein. An offset hole axis 206 of the offset hole 204 is offset from (not intersecting) the rod axis 148 of the sleeve 150 and the plunger bar 152. The offset hole axis 206 may be offset from the rod axis by a distance of from about 12.7 to 25.4 mm (0.5 inches to 1 inch), for example. The offset hole 204 may be offset such that the rod axis 148 does not pass through the offset hole 204. The offset bar collar 200, with its offset hole 204, allows coupling in configurations where an electrical connector is located other than directly below a bail bar. It will be appreciated that the cable retention device 100 shown in FIG. 9 maintains much of the desirable rigid characteristics, while allowing coupling in different relative configurations of the bail bar 146 and electrical connector 124.

FIG. 10 shows another alternative embodiment of the cable retention device 100, in which the structural coupling 102 is a plate 220 having bolt or fastener holes 222 therein. The plate 220 may thus be directly bolted to aircraft structure, using fasteners 230. The cable retention device 100 thus may be secured to the aircraft structure without the involvement of the bail bar 146 (FIG. 8). It will be appreciated that any of a wide variety of suitable configurations of the plate 220 and the holes 222 may be used in securing the cable retention device 100 to the aircraft structure. Any of a wide variety of suitable fasteners, such as bolts, rivets, or screws, may be used. Other suitable mechanisms for attaching directly to aircraft structure may alternatively be used.

The various embodiments of the cable retention device 100 offer many advantages over previous lanyard-based systems. The rigidity of the coupling using the cable retention device 100 allows repeatable positioning and pulling on the electrical connector 124, while still retaining a desired amount of play. Lower forces on the electrical connector 124, and more uniformity in the forces, is expected. At the same time, no alteration in the aircraft structure or in the configuration of present electrical connectors is required.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An aircraft weapon release cable retention device comprising:
a structural coupling configured to couple to aircraft structure;
an attachment mechanism configured to couple to an electrical connector; and
a substantially-rigid rod attached to the structural coupling and the attachment mechanism;
wherein the rod has an adjustable length.

2. The cable retention device of claim 1,
wherein the structural coupling includes a collar with a collar hole therethrough, for receiving at least part of the aircraft structure therethrough; and
wherein a collar hole axis of the collar hole is in a direction at a nonzero angle to a rod axis of the rod.

3. The cable retention device of claim 2, wherein the collar hole axis is substantially perpendicular to the rod axis.

4. The cable retention device of claim 2, wherein the collar hole axis substantially intersects the rod axis.

5. The cable retention device of claim 2, wherein the collar hole axis is offset from the rod axis.

6. The cable retention device of claim 5, wherein the rod axis does not pass through the collar hole.

7. The cable retention device of claim 2,
in combination with a bail bar of the aircraft structure;
wherein the bail bar passes through the collar hole in the collar.

8. The cable retention device of claim 1, wherein the structural coupling includes a plate with fastener holes therein for receiving fasteners therethrough to mechanically couple the cable retention device to aircraft structure.

9. The cable retention device of claim 1, wherein the attachment mechanism includes a forked end with two legs configured to engage the electrical connector.

10. The cable retention device of claim 9,
wherein the legs each have a pair of leg holes therein; and
wherein the attachment mechanism further includes a pair of ties that pass through the leg holes of respective of the legs, to secure the legs to the electrical connector.

11. The cable retention device of claim 10,
in combination with the electrical connector;
wherein the electrical connector has two pairs of diametrically-opposed holes; and
wherein the ties also pass through respective of pairs of the holes in the electrical connector.

12. The cable retention device of claim 1, wherein the rod includes:
a sleeve;
a plunger bar that fits into the sleeve; and
an adjustment mechanism for selectively securing the plunger bar at any of a plurality of different positions, with different amounts of the plunger bar in the sleeve.

13. The cable retention device of claim 12, wherein the attachment mechanism includes a forked end with two legs configured to engage the electrical connector.

14. The cable retention device of claim 13,
wherein the legs each have a pair of leg holes therein; and
wherein the attachment mechanism further includes a pair of ties that pass through the leg holes of respective of the legs, to secure the legs to the electrical connector.

15. The cable retention device of claim 14,
in combination with the electrical connector;
wherein the electrical connector has two pairs of diametrically-opposed holes; and
wherein the ties also pass through respective of pairs of the holes in the electrical connector.

16. The combination of claim 15,
wherein the structural coupling includes a collar with a collar hole therethrough, for receiving at least part of the aircraft structure therethrough; and
wherein a collar hole axis of the collar hole is in a direction at a nonzero angle to a rod axis of the rod.

17. The combination of claim 16,
further in combination with a bail bar of the aircraft structure;
wherein the bail bar passes through the collar hole in the collar.

18. An aircraft weapon release cable retention device comprising:
a collar with a collar hole therethrough, for receiving at least part of an aircraft structure therethrough;
a forked end with two legs configured to engage the electrical connector; and
an adjustable-length rod attached to the collar and the forked end;
wherein a collar hole axis of the collar hole is in a direction at a nonzero angle to a rod axis of the rod; and
wherein the legs each have a pair of leg holes therein configured to receive a pair of ties therethrough, to secure the legs to the electrical connector.

19. The cable retention device of claim 18, wherein the collar hole axis is substantially perpendicular to the rod axis.

20. The cable retention device of claim 18, wherein the collar hole axis substantially intersects the rod axis.

21. The cable retention device of claim 18, wherein the collar hole axis is offset from the rod axis.

22. A method of releasably coupling a munition to an aircraft, the method comprising:
mechanically coupling the munition to aircraft structure of the aircraft;
electrically coupling an electrical connector of the aircraft to an electrical receptacle of the munition; and
securing to the aircraft structure, with a cable retention device, both the electrical connector and a cable coupled to the electrical connector;
wherein the cable retention device includes:
a structural coupling;
an attachment mechanism; and
a substantially-rigid, adjustable-length rod attached to the structural coupling and the attachment mechanism; and
wherein the securing includes:
coupling the structural coupling to the aircraft structure; and
coupling the attachment mechanism to the electrical connector, such that the electrical connector is de-coupled from the electrical receptacle when the munition is released from the aircraft.

23. The method of claim 22, wherein the coupling the structural coupling includes passing a bail bar of the aircraft structure through a collar hole of a collar of the structural coupling.

24. The method of claim 23, wherein the coupling the attachment mechanism includes passing ties through pairs of leg holes of legs of the attachment mechanism, and through corresponding, diametrically-opposed holes of the electrical connector.
